(19) United States
(12) Patent Application Publication
(10) Pub. No.: US 2009/0307610 A1
(43) Pub. Date: Dec. 10, 2009

(54) METHOD FOR A PLURALITY OF USERS TO BE SIMULTANEOUSLY MATCHED TO INTERACT ONE ON ONE IN A LIVE CONTROLLED ENVIRONMENT

(76) Inventor: Melonie Elizabeth Ryan, Sydney (AU)

Correspondence Address: WHITE-WELKER & WELKER, LLC, P.O. BOX 199, CLEAR SPRING, MD, 21722-0199, US

(21) Appl. No.: 12/189,171

(22) Filed: Aug. 10, 2008

Related U.S. Application Data
(60) Provisional application No. 61/060,181, filed on Jun. 10, 2008.

(51) Int. Cl. G06F 3/048; G06F 15/16

(52) U.S. Cl. 715/756; 709/203

(57) ABSTRACT

An electronic Meeting system that utilizes unique methods and processes to create consecutive successions of audio video Meeting Sessions that occur in set blocks of time continuously 24 hours a day, 7 days a week, world-wide across all time zones. The system provides for a plurality of Members to be simultaneously matched real-time to other Members, using varied matching preferences, for a series of short Meetings to interact one on one for a fixed period of time in a controlled environment. The use of a live Countdown Clock Display allows for a spontaneous use of the system by visually communicating to Members that a Check-in Process for Meetings is always available.

### CROSS REFERENCE TO RELATED APPLICATIONS:

This application claims priority from U.S. Provisional Patent Application SN 61/060181, entitled “METHOD FOR A PLURALITY OF USERS TO BE SIMULTANEOUSLY MATCHED TO INTERACT ONE ON ONE IN A LIVE CONTROLLED ENVIRONMENT”, filed on 10 Jun. 2008.

### TECHNICAL FIELD OF THE INVENTION

The present invention relates generally to a method for social interaction in an electronic environment. More specifically, the present invention relates to a social networking system for electronic meeting.

### BACKGROUND OF THE INVENTION

The present invention concerns matching. In particular, the present invention concerns engaging and matching people anywhere in the world real time in order for them to have a desired number of one on one electronic Meetings in a controlled environment.

Electronically, concepts of “matching” are commonly exemplified by online dating services. Also, concepts of “matching people for short Meetings or dates” are well exemplified by real life and online speed dating services. Rabbi Yaacov Deyo and his students in Los Angeles, Calif. have been credited for this “round robin dating” that Rabbi branded as SpeedDating®.

Many individuals and corporations now realize that certain flavors and elements of the above concepts can be enhanced and applied to create new business processes. An example of an application is “Speed Mentoring” to find business mentors internally within a large organization or across companies. Another application is known as “Speed Networking” where people come together at events, trade shows and conferences in a series of short meetings with new contacts to enhance business networking or generate leads. Yet another application is “Speed Recruiting” where prospective clients and employees come to interact with training or recruiting entities.

Because certain parallels exists with both matching and speed dating concepts discussed and the present invention, certain limitations of the common application of the two concepts are discussed which the present invention aims to satisfy in order to better its execution.

With regard to electronic dating services, many are still heavily based around profile searching and matching. While matching capabilities have generally improved, these services still commonly return only profile or contact information of candidate matches back to members rather than provide members a method of immediately interacting with candidate matches face to face.

Many members also find they have to refine their matching profiles and preferences recursively before they are happy with the quality of candidate matches returned by searching profiles. This process involves firstly making changes to their profiles and desirables, then doing a search and observing the quality of candidate matches returned, and redoing this process again and again until the member is satisfied. There has not been much improvement in helping members immediately predict the possible effects of changes they are making to their profiles and matching preferences on their matching potential.

Another common practice is that many matching services may find matches for a member while the member is away and not logged on to their service. The member in this case is sent information about his candidate matches via emails or some other communication method. In most cases, members are required to log back into the service again in order to view their candidate matches. Also in most cases, members are not presented any information on times when their candidate matches would be next available for interaction. In some services, members may even be required to pay in order to view profile information of their candidate matches or to initiate contact with them.

Next, a member still has to initiate contact in order to interact with their candidate matches. This method of profile searching and matching is a very slow and delayed form of matching which has too much process before a member gets the opportunity to actually interact with their candidate matches.

To add to this, in many electronic dating services, the methods by which members have to initiate and manage interaction with their candidate matches or with members they have found by searching profiles, also have too much process. Many services purely rely on members exchanging internal electronic messages to initiate and maintain communication. By its very nature, electronic messaging is a delayed form of communication. Many dating services also allow members to exchange electronic gestures such as winks, kisses, flirts, pokes and the like. The idea is to ignite interaction with other members in a rather subtle manner. In reality, there is no guarantee a member will ever get a response back for their electronic gestures. Even if they do, it may take a few of these gestures and then maybe a few electronic messages before two members progress to a real-time one on one conversation. This too is a long-winded method of interaction.

Some electronic speed dating services allow members to speed date using electronic text-based chat methods. Electronic text-based chats are not only slower than live audio video chats, but they also impede members to determine good first impressions and chemistry with their candidate matches, thus moving away from the essence of speed dating. Therefore what is needed is a method that provides faster interaction.

Another problem that has prevailed for profile-based dating services is that some members abuse the service by creating fake profiles and misrepresent their true personal appearance. This in turn means their matches can be misled for a prolonged period of time as to a true representation of the identity of the abusing members, especially if the primary form of interaction allowed on the service is purely via electronic messages or text-based chat. Therefore what is needed is a method that uses video, and discourages fake profiling as a user cannot hide behind a profile.

Many prior art already describe electronic text-based as well as audio video interaction-enabled technologies that allow for immediate dating methods, invitational, one-on-one or group-dating methods and scheduled events-based dating methods utilizing matching methods based on certain matching criteria to match people; and electronic speed dating services.

Also common in prior art or electronic speed dating services, a set of members may be pre-selected from the total pool of members based on certain criteria. An example of a general criterion could be “singles in Melbourne, Australia”. An example of a more targeted criterion could be “professional singles over 35 yrs in Melbourne, Australia”. These members are then invited to participate or alternatively they may be presented information for upcoming scheduled, electronic group dating or personal dating events. In some services, all members of the service are presented information for the upcoming events and members can choose to express their interest in participating at an event in advance.

Certain prior art also mention users can “browse” events or sessions in order to select which ones they want to participate in. In some cases, times for dating events are listed in various different time zone codes. This may potentially create confusion for members who are not well versed with time zone codes coupled with the added pressure of managing daylight savings changes in certain countries. In certain prior art and electronic dating services, a member may be able to invite other members to a future date event as well.

In most cases, members who suit the criterion for the event, and who have expressed interest to participate at an event, further have to confirm their participation in advance. Later, these members have to be logged in and ready at the exact scheduled time in order to participate in the event.

Certain prior art and electronic speed dating services also mention that if the number of members who have confirmed to participate for the scheduled group dating or personal dating event are insufficient before the event, the event may be cancelled and the members may be electronically informed of the cancellation. Therefore what is needed is a method that does not need members to confirm participation prior to the Meeting and has no expectation that a member be strictly logged in at a scheduled time in order to meet. Members should be able to participate in Meetings whenever they feel like it in an electronic Meeting environment. Additionally, the present invention does not need cancellations.

Also present in some prior art and electronic dating services is a method of immediate electronic dating. In this method of Meeting, members who are logged in may choose to go on an immediate date. Members may be able to specify certain search criteria that they want to influence the outcome of their candidate matches. Next a search is carried out and if a compatible match is found, both members can be matched for immediate dating. Some also see this method as a form of electronic speed dating. After this date is complete, members may choose to go on another immediate date. In some services, if no compatible matches are found, there may be a predefined timeout period only after which the member is informed that no compatible matches were found. The problem is that in the case of some of these services, this timeout period, which can be over 10 minutes at a time, is not obvious or is not clearly presented to members and therefore members sometimes feel they have to wait for an indefinite and unspecified amount of time until a compatible match becomes available.

Another problem with this method of immediate dating, and with invitational and event-based electronic dating services mentioned above, which is also a limitation of prior art, is that there is generally no provision for members to login electronically and select a set number of electronic dates they would like to participate in immediately. Therefore what is needed is a system that allows members to select a set number of Meetings.

Yet another problem with some electronic speed dating services is that while a member is having an actual real-time speed date with a newly matched member using audio video or text-based chat facilities, the service may also allow, through the same system environment, the member to be interrupted by and to simultaneously manage interactions with other previously matched members, or with members in their service contact list, who may also currently be logged into the service. A common form of this interaction is text-based chat. This goes against the spirit of speed dating, which is meant to be a series of one on one interaction with matched partners, for a fixed period of time, without any distractions by other participating members.

Another limitation of electronic speed dating services is the absence of a friendly feedback rating system, where friendly feedback rating can become a permanent part of a members visible profile while speed dating, in order to help promote a friendly and responsible environment. Therefore what is needed is a system that has a compulsory Friendly Feedback system.

With electronic medium such as the Internet, electronic Meetings can now span globally across different countries and time zones. This in turn may allow members to select target locations around the world in search of their candidate Meeting matches. While prior art or speed dating electronic services may successfully match members globally, they have not commonly addressed the opportunity of presenting members interactive live statistics and trend estimation statistics as well as other targeted information about their target locations and about the service. One advantage of doing this is that this empowers members to discover popular usage trends in target locations in order to determine their preferred times and other specifics of Meeting. Another advantage is that the system or members may also be able to plot interesting information on a shared or private statistics area.

What is needed is a system that may learn from but is not purely based around profile searching and matching. Matching systems should be able to determine immediately if candidate matches exist for a member, from the total pool of members electronically logged into the system at the same time, who may be available for a Meeting. This provides members instant gratification of being able to determine a potential new partner or friend or associate in a matter of minutes.

What is needed is a system that indicates real-time to Members how selections or changes they make to their profile and matching preferences may affect their matching potential.

Members should also be empowered to interact one on one with their candidate matches using audio and video technologies easily and quickly without too much process.

What is needed is a system that clearly informs members within a set period of time, whether a match was found for a session or immediate Meeting or not. Members should clearly be able to see the time remaining until the start of the next process in the session. This ensures members never feel they need to wait for an indefinite and unspecified amount of time for matches to become available for Meeting.

What is needed is a system that does not rely on sending invitations to Members to future event-based Meeting sessions. What is needed is a system where Members do not need to rely on receiving invitations and confirming participation to imminent or future Meeting sessions.

Therefore what is needed is a system that allows members to login to electronically participate in Meetings real-time, whenever they feel like, at any time of the day, or night, in any location of the world, across any time zone.

To further complement this, what is needed is a system that conveniently converts times across different time zones to a member's local time whenever it needs to relay time-specific information. Examples of these may be popular times of use globally and popular times of use for a particular target location or for a target candidate match converted to a member's equivalent local time.

What is needed is a system that allows members to select a set number of Meetings they want to have.

As a better alternative to invitation or events-based dating, and as an extension of real-time matching and speed dating, members may be allowed to publish Meeting times for imminent calendar dates to help create and manage dynamic hotlists that increase the anticipation and chances of being matched to someone if members times and compatibility preferences match.

What is needed is a system that allows matched members to interact face to face with other members for a limited period of time, without any obligation to continue the communication so that members can benefit from determining a mutual interest without unnecessary embarrassment or alternatively not experiencing any guilt by expressing rejection.

What is needed is a system that does not allow interruptions or interactions with previously matched members, members in their system contact list or other members, while a member is having an electronic Meeting with a new matched member, within the same system environment.

### SUMMARY OF THE INVENTION

Embodiments of the present invention include methods and systems for an electronic Meeting system to utilize a consecutive succession of audio video Meet Sessions that occur in set blocks of time continuously 24 hours a day, 7 days a week, world-wide across all time zones. One embodiment of the present invention includes an unlimited number of Members to be simultaneously matched real-time to other Members, using varied matching preferences, for a series of short Meetings to interact one on one for a fixed period of time in a controlled Meeting environment. One embodiment of the present invention includes a live Countdown Clock Display to visually communicate and present to Members a Check-in Process that is always available for Meeting allowing for a spontaneous use of the system.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates the Timer Device 100 synchronization of the present invention;

FIG. 2 is a flow diagram illustrating the Check-in Process 300 of the present invention;

FIG. 3 is a flow diagram illustrating the Matching Process 402 of the present invention;

FIG. 4 is a flow diagram illustrating the Meeting Process 110 and an example of four Meeting Sessions 312 of the present invention;

FIG. 5 is a flow diagram illustrating the Review and Confirm Process 428 of the present invention;

FIG. 6 illustrates parts of the Meeting Console 600 and example of a Meeting 412 in Progress of the present invention;

FIG. 7 illustrates parts of the Meeting Console 600 and an example of a Voting Interval 414 in Progress of the present invention;

FIG. 8 illustrates parts of the Meeting Console 600 and an example of the Review and Confirm Process 428 of the present invention;

FIG. 9 illustrates parts of the Members Results Area Panel 900and an example of a dynamic panel of Successful Meeting Results 906 of the present invention;

FIG. 10 illustrates parts of an example Interactive Statistics Display 104 of the present invention and also shows an example processing flow that can be used to populate it; and

FIG. 11 is a high level block diagram illustrating the IT environment of the present invention.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, the system-known structures and techniques known to one of ordinary skill in the art have not been shown in detail in order not to obscure the invention.

The present invention offers an electronic Meeting system that utilizes unique methods and processes to create consecutive successions of audio video Meeting Sessions that may occur in set blocks of time continuously 24 hours a day, 7 days a week, world-wide across all time zones.

The system provides for an unlimited number of members to be simultaneously matched real-time to other members, using varied matching preferences, for a series of short Meetings to interact one on one for a fixed period of time in a controlled Meeting environment.

The present invention introduces a live Countdown Clock Display that continuously counts down the set amount of time between consecutive Meeting sessions. The Countdown Clock Display also presents a count down of time remaining during Meeting Sessions.

The use of a live Countdown Clock Display visually communicates to members that a Check-in Process for Meetings is always available. This allows for a spontaneous use of the system and eliminates time zone code confusion and the dependency of scheduled or invitation based Meeting events.

The present invention introduces a Check-in Process that allows members to slot into the next Meeting Session, select the number of Meetings they want to have and select their Matching Preferences.

The present invention introduces a Matching Process where Members, who have become available through the Check-in Process, are matched real-time to other Members who are also checked-in for Meeting. The Matching Process may also, in some applications, ensure members will never be matched for a Meeting with the same member more than once.

Matching Preferences allow Members to be matched using a variety of methods. This helps create a Meeting system that suits all members with different individual needs.

One method may be Basic Matching Preferences where members are matched using a very small number of specifics in order to achieve a greater aggregate of candidate matches.

Another method may be Targeted Matching Preferences where members want to be matched more closely using specific attributes and desirables they seek in their candidate matches.

Another method may be Specialized Themed Matching Preferences where members want to be matched more closely to their candidate matches based on specific themed interests rather than only specific attributes and desirables.

Yet another method may be Dynamic Hotlist Matching Preferences where members publish their location, preferences and anticipated times for Meeting with the aim to be matched to potential compatible members who respond by creating dynamic hotlists that are populated by this published information.

Members are also allowed to make changes to their Matching Preferences on each Check-in and these changes influence their matching immediately.

The present invention also introduces Matching Strength Meters, which dynamically update real-time to indicate how changes in a member's profile and matching preferences may affect their matching potential. These Matching Strength Meters help members immediately gauge how limiting or extensive their matching potential may be.

The present invention introduces a Friendly Feedback system where members are required to rate each Meeting partner's friendliness. This ensures every member has a visible history of friendliness in his or her visible profile. This encourages members to be responsible while Meeting and promotes a friendly environment by displaying a visible consequence.

For the present invention an electronic Meeting Session consists of the following: candidate matches are paired to interact as Meeting Partners over a series of short Meetings using audio video technologies separated by a Voting Interval, both lasting a controlled amount of time.

As part of the Voting Interval, every member is required to vote a definitive ‘YES’ or ‘NO’ for each Meeting Partner, where only ‘YES’ votes by both Meeting Partners determine a successful Meeting.

During the Voting Interval, every member is also required to rate their Meeting Partner's friendliness and other attributes. This helps determine every Member's Friendly History that is displayed while Meeting. Member can also choose to create Reminder Notes about the Meeting Partner.

The present invention introduces a Review and Confirm Process that allows members the option to ‘Review and Confirm’ their votes before a final submission, once all of their Meeting Sessions are complete. This process allows members to change their ‘YES’ or ‘NO’ votes, finish rating any incomplete votes and continue making personal Reminder Notes.

The present invention also introduces a P.S Note in the Review and Confirm Process that allows Members to send a follow up note only to a partner they have voted ‘YES’ to. If the match is successful, this P.S. Note is delivered to their successful Meeting partner interactively.

After confirming all their votes, Members may choose to Check-in to another Meeting Session or instead Check Out of Meeting to review their Results in the member's area.

Results of a Meeting Session are available to Members after a short period of time. If both Meeting partners say ‘YES’ to each other, the Meeting is published as a ‘successful Meeting’ and details can be found only within each respective members private ‘Results’ page. In some applications, only successful Meetings may be published. To help reduce negative experiences, all ‘NO’ votes and unsuccessful Meetings may never be published.

The private ‘Results’ page may publish a Profile of each successful Meeting partner. Within the ‘Results’ page, Members can also review any P.S Notes, and review and add to their Reminder Notes for each partner.

The ‘Results’ page may also present Members the opportunity to continue communication with their successful Meeting partners using a variety of methods, both on and outside the system environment.

One method may be an option to add successful Meeting partners to a personal contact list. This allows Members to request their successful partners as contacts to one or many of their Instant Messaging, VOIP or other audio video interaction clients and social networking services or address books. If their successful Meetings accept their requests, they can easily continue to communicate without any restrictions in any agreed manner and times in order to get to know each other better. This may happen independent of their system membership and outside the system environment.

Another method may be an option to send system Internal Messages; and an option to send system External messages.

Therefore the invention aims to tightly control major elements of the Check-in Process, Matching Process, Meeting Process, and user account management. This allows the invention to focus on Meeting Sessions as a controlled experience where members are required to use these methods and processes that are completely regulated in order to participate. In turn, the invention allows successful Meeting partners to communicate easily in or outside the system environment.

The present invention further introduces Interactive Statistics Displays that may provide Members with statistics including but not limited to live statistics, trend estimation statistics as well as targeted information about a Member's target Meeting locations, popular times of usage, Meeting-related and other information about the system. These Interactive Statistic Displays help influence a member's choice of Meeting times, matching preferences and general interaction.

One application of an Interactive Statistic Display is an Interactive Map that may display statistics to members of how many members are currently logged into the system in a particular location they are viewing, the most popular times of use in that location and the most popular overall time of use worldwide. Times may further be displayed conveniently converted to the member's equivalent local time. This Interactive Map may help members understand the evolution of the system's community and also to learn the best times of use in their target Meeting locations, their time. The system may also allow members to contribute by populating the map with further information for other members to view.

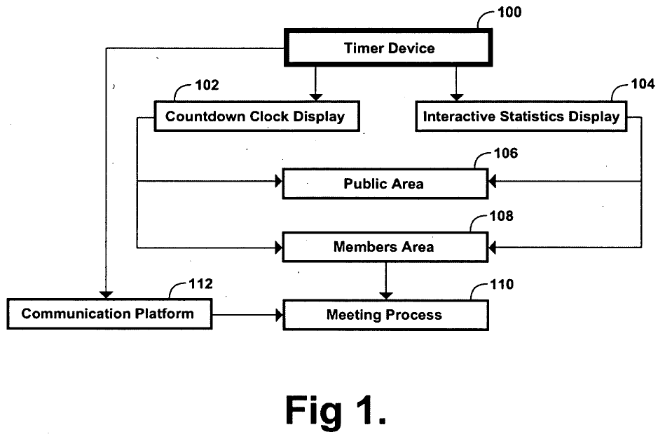

Referring to the figures, it is possible to see the various major elements constituting the apparatus of the present invention. Now referring to FIG. 1, the Timer Device 100 synchronization of the present invention is illustrated. The Timer Device 100 manages time system-wide and allows a unique method of ensuring a continuous succession of Meeting Sessions 312 to which the entire present invention is synchronized.

One of the first unique elements of the invention visitors and Members see is the Countdown Clock Display 102. The Timer Device 100 governs the Countdown Clock Display 102, which is visible in both the Public Area 106 and Members Area 108 of the system.

The Countdown Clock Display 102 communicates to visitors and Members a continuous count down cycle that runs real-time every few minutes, repeating its cycle, to indicate exactly when a Meeting Session 312 will start and end. Essentially the live Countdown Clock Display 102 is a method of unifying Meeting Session 312 times across the world's different time zones and also ensuring that Members are not waiting for an indefinite or unspecified amount of time to start the Meeting Process 110 or between Meeting Sessions 312.

The Countdown Clock Display 102 enables a spontaneous use of the system by allowing Members to check-in for Meetings real-time, anytime, 24 hrs a day without having to “browse” upcoming sessions or requiring pre-selection and invitation to a scheduled Meeting event or sessions for which they have to confirm participation.

The Countdown Clock Display 102 may be displayed in any shape or form with the intention of communicating the continuous succession of Meeting Sessions 312 and time duration within Meeting Sessions 312.

The Public Area 106 could be described as any area of the system that anyone, Members as well as non-Members can access. The Members Area 108 could be described as any area of the system that only Members gain access to after they have logged in electronically using their unique Members Nickname and other login details.

The Timer Device 100 governs the start, the end and each step in the Meeting Process 110, which makes use of a Communication Platform 112 to conduct each Meeting Session 312. The Communication Platform 112 may be described as technology and methods that provides audio video interaction capabilities to the system.

The Timer Device 100 also allows the Countdown Clock Display 102, which is visible during each Meeting Session 312, to count down each stage of the Meeting Session 312.

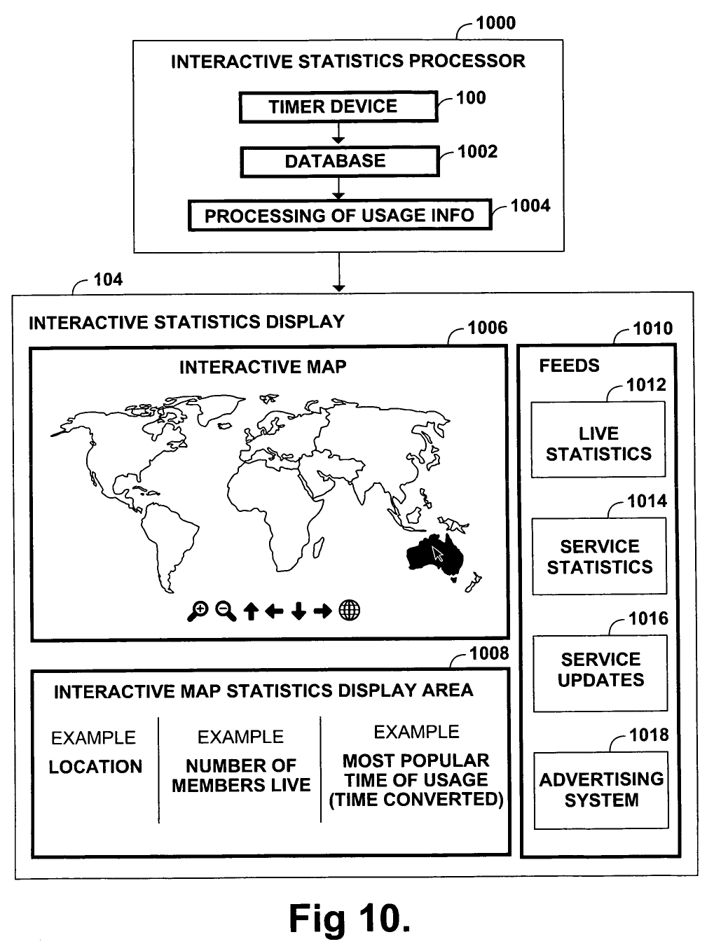

The Timer Device 100 is also used to calculate various statistics that can be displayed using Interactive Statistics Displays 104, which appear in the Public Area 106, Members Area 108 and within the Meeting Process 110. An example of an Interactive Statistics Display 104 is shown in FIG. 10.

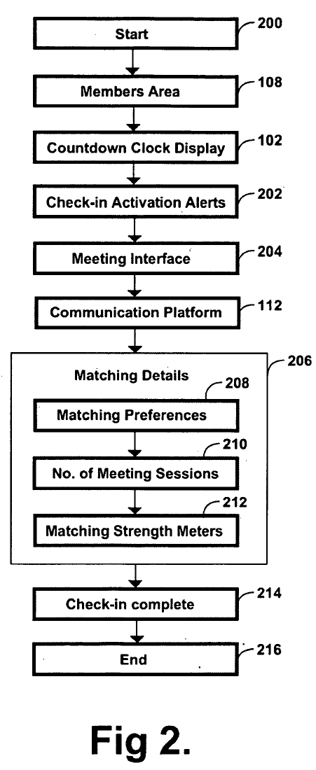

Now referring to FIG. 2, using the Countdown Clock Display 102, Members can initiate the Check-in Process 300 to make themselves available for Meeting. The Check-in Process 300 is an integral part of the Meeting Process 110 and helps manage the continuous succession of Meeting Sessions 312.

The Check-in Process 300 is available through the Members Area 108. A Check-in Activation Alerts 202 method is used to display a series of timed activation alerts that are synchronized to the Countdown Clock Display 102. The alerts visually transition from one to another at specific times to indicate the urgency of limited Check-in time remaining to join the next Meeting Session 312. The alerts also help visually communicate the continuous succession of Meeting Sessions 312.

An example of a series of Check-in Activation Alerts 202 could be that in the first few minutes of a new Countdown Clock Display 102 cycle, a Check-in Activation Alert 202 indicates that Check-in for the next Meeting Session 312 is now open. In the following few minutes, a Check-in Activation Alert 202 indicates a last call for Check-in and in the final few minutes, a Check-in Activation Alert 202 indicates that the Check-in is now closing.

During the Check-in Activation Alerts 202 method, the transitions between these visual alerts may be indicated by change of color, form and may even be animated or flash to indicate the urgency of limited time remaining to join the next Meeting Session 312.

When the Countdown Clock Display 102 has finished counting down the time remaining, Check-in is closed for the upcoming Meeting Session 312 and the Check-in Activation Alerts 202 cycle starts all over again for the next Meeting Session 312.

When a Member selects any of the Check-in Activation Alerts 202, the Check-in Process 300 will Start 200 and Members start interacting with the Meeting Interface 204.

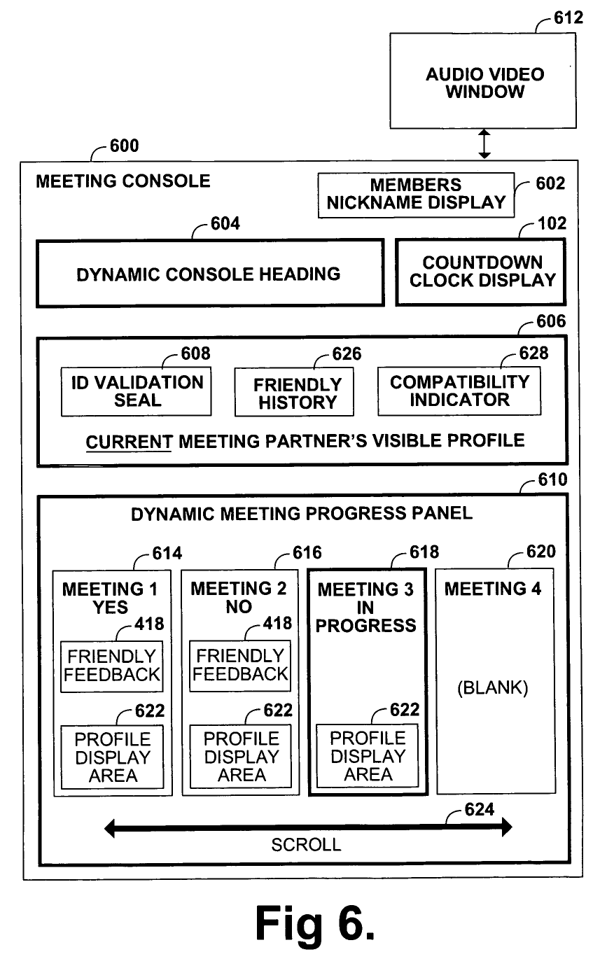

The Meeting Interface 204 works with a Communication Platform 112 to allow Audio Video interaction between system Members. The Meeting Interface 204 may be described as technology consisting of hardware and software working together to allow electronic Meeting capability on a client using a variety of methods. The Meeting Interface 204 is responsible for presenting to Members The Meeting Console 600, as shown in FIG. 6. The Meeting Console 600 is effectively an interactive control panel for Meeting.

The Communication Platform 112 may be described as technology and methods that provides real-time audio video interactive capabilities to the system.

One method of executing Meetings involves using a system-enabled plug-in implementation that works together with an existing electronic audio video interaction-enabled platform and the system to deliver electronic video Meeting Sessions 312. Examples of such audio video interaction-enabled platform may include VOIP services such as Skype and other common Instant Messaging platforms that have APIs.

An example of this working is using the system-enabled plug-in to provide the Meeting Console 600, and this synchronizes with a audio video interactive platform to provide an Audio Video Window 612 for Meeting. They work together. APIs of proprietary or non-proprietary applications may make this possible.

A second method of executing Meetings involves using the system-enabled implementation that may use the system-browser or browser-like application to deliver Meeting Sessions 312.

An example of this working would be that the system-browser or browser-like application that is running on a Member's system-enabled device, which may be a computer, a mobile device, a TV device or even a system-enabled gaming console, interfaces with the system to host both the Audio Video Window 612 as well as the system Meeting Console 600 Panel on the same screen.

A third method involves a local application that gets installed and runs on a Member's system-enabled device. Once connected to the system, the system pushes Meeting Console 600 Panel information and Audio Video Window 612 onto the local application windows.

Next in FIG. 2, Members progress to specify their Matching Details 206. Matching Details 206 involves Members submitting their Matching Preferences 208, selecting the Number of Meeting Sessions 210 and viewing Matching Strength Meters 212. Matching Preferences 208 allow Members to be matched using a variety of methods. This helps create a system that suits all Members with different individual needs.

One method may be Basic Matching Preferences where Members are matched using a very small number of specifics in order to achieve a greater aggregate of candidate matches for them. One example, applied in a dating scenario, may be matching Members using only the following; Gender, Age, and Location.

Another method may be Targeted Matching Preferences where Members want to be matched more closely by clearly specifying specific attributes and desirables they seek in their candidate matches. Members may also be presented character analysis methods and business intelligence to help improve their matching. Some examples of attributes and desirables may be education level, industry and occupation.

Another method may be Specialized Themed Matching Preferences where Members want to be matched more closely to their candidate matches based on specific themed interests rather than only specific attributes and desirables. Themed interests may involve matching targeting specific business activities, social networking, cultural activities, hobbies, travel and more.

Yet another method may be what the invention calls ‘Dynamic Hotlist’ Matching Preferences. This method may also be an extension to the other methods of Matching Preferences 208 mentioned above. In this method, Members may have the option to publish their planned Meeting information in advance to attract personal attention from prospective compatible Members. A personal electronic calendar implementation may allow publishing Members to select imminent calendar dates from a system personal electronic day/week/year calendar. When they select a particular calendar date, they are able to specify any times for that day or night to indicate when they plan to be available for Meeting. Publishing Members may also inform about the location such as a city or country where they will be during their Meeting. This will enable the system to convert a Member's published available times to any viewing prospective compatible Member's equivalent local times. Publishing Members may also define Matching Preferences 208 for which type of Members they would like to share their times with.

This information may be shown to prospective compatible Members when they are looking up imminent calendar dates from their system personal electronic day/week/year calendar. When they select a particular calendar date, they are able to select any times for that day when they plan to participate in Meetings. They may be presented a list showing publishing Members that they may be compatible with, and who may be available for Meeting during the times they are looking up. The system may allow them to create Dynamic Hotlists showing publishing Members corresponding to these times. The aim of a Dynamic Hotlist is to increase the chances of Meeting with publishing Members but without relying on invitations or confirmations to any Member's published times. The system may further allow Members to communicate their interest for Meeting to publishing Members using their Dynamic Hotlists.

Based on responses, publishing Members may be presented an increasing list of prospective compatible Members who may be available and who have expressed interest in Meeting with them at their published times. Publishing Members may further have the option to filter these Members to create a Dynamic Hotlist of the Members they may be interested in Meeting with. If on the day, the Matching Preferences 208 of both a publishing Member and a prospective compatible Member still match at the time their Dynamic Hotlists relate to, and both Members are Checked in to the system, the two Members may be ranked closer in priority to be matched to each other for real time Meeting. If however, any of the two Members have made changes to their Matching Preferences 208 during Check-in that disqualifies the previously prospective compatible Member as a match now, and they have clearly indicated they want to enforce these changes to affect all their current Dynamic Hotlists, the changes may influence their matching and they may no longer be matched, even if they are Checked-in and available at the published time.

The advantage of this method is that Dynamic Hotlists are always current and they present a real and achievable list of prospective compatible Members for imminent calendar dates at a specified time.

Another advantage of Dynamic Hotlists of the present invention is that since all times are conveniently converted to equivalent local times for both Members, a prospective compatible Member actually has a real chance of meeting a publishing Member, even if they are in different time zones, as long as they still appear in each other's Dynamic Hotlist.

Yet another advantage is that there is no pressure or requirement for any Members to confirm their participation for Meeting on a future day and time. -Members are not required to Check-in to the system strictly before a specific time, get authenticated and be ready for the scheduled Meeting to occur. So long as both Members have checked in for Meeting during the same block of time as their compatible Dynamic Hotlist Member and are not on their final Meeting, they may be ranked closer to be matched to each other.

Also the traditional method of creating simple static hotlists based on profile searching and matching would not be useful for this invention as two compatible Members who may be in completely different time zones may never get to find out the best time for Meeting each other, since the invention is not based around slow forms of electronic text-based messaging.

Once the times relating to a Dynamic Hotlist has passed, this Dynamic Hotlist may either remain or disappear from a Member's system personal calendar section as it has served its purpose. Members may continue to create Dynamic Hotlists for imminent calendar dates.

A possible revenue model for the system may involve providing some Matching Preferences 208 methods for free and others as paid services. As an example, Basic Matching Preferences could be free for all Members to use while Targeted Matching, Specialized Themed Matching and Dynamic Hotlist Matching may be offered as a paid service.

Next in FIG. 2, a unique element of the invention that the Check-in Process 300 introduces is that Members are required to select the consecutive Number of Meeting Sessions 210 they would like to participate in. The system can clearly communicate to Members how long it will take to complete their chosen Number of Meeting Sessions 210. There may also be a minimum and maximum Number of Meeting Sessions 210 a Member can choose to participate in, in one seating.

Continuing in FIG. 2, another unique element the invention introduces within the Check-in Process 300 is Matching Strength Meters 212. As a Member makes changes to his or her profile and Matching Preferences 208, which may include changing attributes and desirables, themes and anticipated times of Meeting, Matching Strength Meters 212 visually update real-time to indicate how their selections or changes are affecting their matching potential.

As an example, applied to a dating scenario, is where a Member changes his Matching Preferences 208 to be matched to a compatible Member between the ages of 18 years to 35 years anywhere in the world rather than only in New York City, he may have increased his chances of being matched considerably. The Member may be allowed to check real-time for candidate matches currently on the system or who have previously published Meeting times. If the number of candidate matches found is significant and is well above the Number of Meeting Sessions 210 he has opted for, the Matching Strength Meters 212 may visually show an increase in strength of his matching potential for the anticipated sessions.

Multiple Matching Strength Meters 212 may also be deployed to indicate changes to a Member's matching potential real-time in specific categories, attributes or preferences. One example, applied in a dating scenario, may be that a member who wishes to be matched to any compatible females in Australia for Meeting may also wish to see which Australian State results in the most favorable number of candidate matches as he edits his profiles and Matching Preferences 208. As he applies his changes, different Matching Strength Meters 212 for each Australian State could be displayed to him showing the strength of his matching potential for each State.

Another example, applied in a recruitment scenario, may be that a member who wishes for Meetings with recruitment agency officials with published times in Australia on a particular day, may also wish to see which Australian State will have the most number of officials available, as he edits his profiles and Matching Preferences 208. As he applies his changes, different Matching Strength Meters 212 for each Australian State could be displayed to him showing the strength of his matching potential for each State real-time.

Matching Strength Meters 212 may be displayed as visual meters in any shape or form with the intention of displaying real-time to Members the changes in strength of their matching potential. Once the Matching Details 206 have been completed and submitted by the Member, Check-in Completes 214 and this Ends 216 the Check-in Process 300.

An immediate benefit of this unique Check-in Process 300 is that it partitions Members who have committed to participate in a consecutive Number of Meeting Sessions 210 real-time. This means Members can be matched regardless of which Meeting Session 312 they checked-in to or the consecutive Number of Meeting Sessions 210 they committed to complete. As an example: Member A completes the Check-in Process 300 committing to five consecutive Meeting Sessions 312 and starts Meeting. During Member A's third Meeting Session 312, Member B completes the Check-in Process 300 committing to eight consecutive Meeting Sessions 312 and waits for their first Meeting Session 312 to start. Member A and Member B are found to be compatible and are matched for the next Meeting Session 312. Member A's fourth Meeting Session 312 is Member B's first Meeting Session 312.

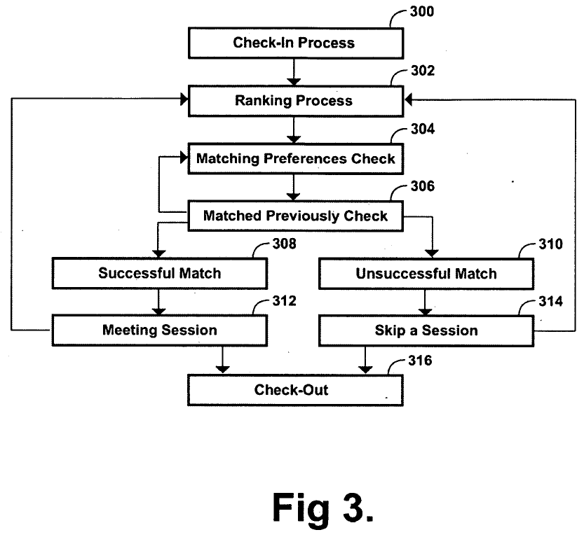

Now referring to FIG. 3, Members who have completed the Check-in Process 300 are next made available for the Matching Process 402.

The Matching Process 402 may contain the following steps: Check-in Process 300, Ranking Process 302, Matching Preferences Check 304, Matched Previously Check 306, Successful Match 308, Unsuccessful Match 310, Meeting Session 312, and Check-Out 316.

The Ranking Process 302 requires that Members be ranked according to certain criteria to formulate a list of checked-in Members. Examples of criteria for ranking Members for matching may include assigning a higher priority to Members who have subscribed for priority matching, such as using Specialized Themed Matching Preferences, assigning a different priority to Member's who have checked in with Basic Matching Preferences and assigning a different priority to Members who use the system frequently. Those who are at the top of this list are matched first. This ensures that prioritized Members are ranked higher and the Matching Process 402 produces the most number of possible matches.

Matching Preferences Check 304 requires that a Member at the top of the list is selected and is attempted to be matched to the next member on the list. If the Matching Preferences 208 of the two Members is compatible, then they are recorded as a possible match. If the preferences are not compatible, the next Member on the listed is tried.

Matched Previously Check 306 provides that two Members of a possible match are checked if they have been matched previously on a Meeting 412. If the two Members haven't been matched previously then it is considered a Successful Match 308. If they have previously had a Meeting, the next Member on the Matching Preferences Check 304 list is tried.

A Successful Match 308 produces a Meeting Session 312 for the two Members while an Unsuccessful Match 310 results in the Member having to Skip a Session 314 and wait for the next session. Once a Meeting Session 312 is over, if a Member has checked in for more sessions, the Matching Process 402 for this Member is started again at the Ranking Process 302. Once all sessions that the Member has checked-in for is complete, the Member selects Check-Out 316 and is checked out of the Matching Process 402.

One way of stating the matching process in pseudo code is using two functions; a Match function that accepts a list of checked-in Members to return a list of matched Members; and a Find Match function that it uses to accept a list of checked-in Members and compares their Matching Preferences 208 against a Member, and either returns two matched Members if their preferences match or it returns a null as shown:

### Match Function

Accepts a list of Checked-in Members and returns a list of matched Members.
WHILE the list of checked-in members are not empty
Remove the first member on top of the list
CALL FindMatch with list of checked-in Members and the first member on top of the list IF match was found THEN
Add the 2 matched Members to the matched Members list

### ELSE

Add the unmatched member and Null to the matched Members list END IF
END WHILE
RETURN list of matched Members
FindMatch Function
Accepts a list of checked-in Members and a Member, returns 2 matched Members or null FOR each Member in the list of checked-in Members

IF the Member from the list has not had a Meeting with the Member AND the matching preferences of the member from the list matches the matching preferences of the Member THEN

Remove the matched Member from the list of Checked-in Members

RETURN the 2 matched Members
END IF
END FOR
RETURN Null

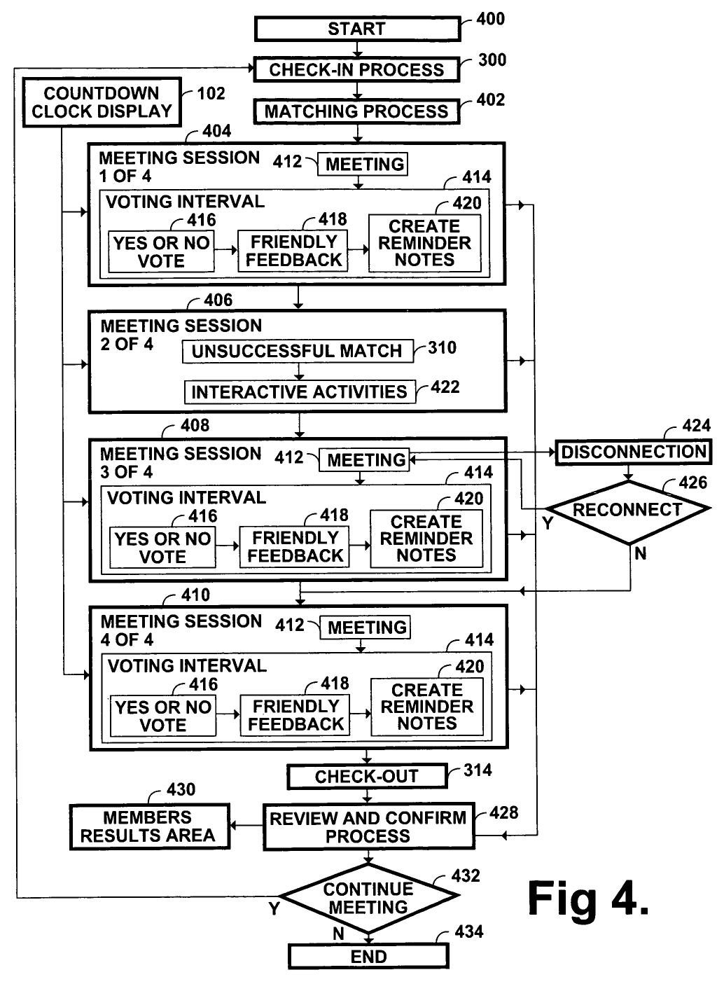

Now referring to FIG. 4, after the Matching Process 402 has identified candidate matches for Members based on their Matching Details 206, the Meeting Sessions 312 can commence. In the diagram, an example of four Meeting Sessions 312 is illustrated.

The unique Meeting Process 110 may largely consist of the following parts: Check-in Process 300, Matching Process 402, the Members chosen Number of Meeting Sessions 210, Check-Out 316, and the Review and Confirm Process 428.

With reference to the four Meeting Sessions 312 examples illustrated, to Start 400 the Meeting Process 110, a Member completes the Check-in Process 300, and the Countdown Clock Display 102 indicates the time remaining until the first of four Meeting Sessions 404 is to commence.

Within the Meeting Console 600, a Dynamic Console Heading 604 may prompt the Member to get ready and flash to indicate the urgency of limited time remaining for the first Meeting Session 404 to commence. This method may also be used to prompt Members in each stage of the Meeting Sessions 312.

While a Member is waiting for a Meeting Session 312 to commence, the system may provide helpful information and relevant service statistics and updates. The system may also provide options for Members to quickly promote the system to someone else electronically.

If a Successful Match 308 is found, illustrated in FIG. 4 as Meeting Session 404, 408 and 410, a session is divided into two parts, a Meeting 412 followed by a Voting Interval 414. Both occur for a controlled period of time.

A Meeting 412 is experienced in the form of a one on one Audio Video connection between two successfully matched Members and the system.

During a Meeting 412 the Meeting Console 600 is displayed and an Audio Video Window 612 enables the Members to interact real-time with each other. When a Meeting Session 312 starts, the Countdown Clock Display 102 starts counting down the time remaining for each Meeting 412 to finish.

A nudging system may also be used for Members to interact using gimmicky expressions and emoticons to enhance communication during a Meeting 412. This interaction may be executed in the Meeting Console 600 or in the Audio Video Window 612 or in any combination of the two.

After a Meeting 412 is complete, there is a Voting Interval 414 for Members to submit a response about the most recently completed Meeting 412. When the Voting Interval 414 starts, the Countdown Clock Display 102 starts counting down the time remaining for the Voting Interval 414 to finish and the next Meeting Session 312 to start.

Firstly, during the Voting Interval 414, a Member is required to choose between a YES or NO Vote 416.

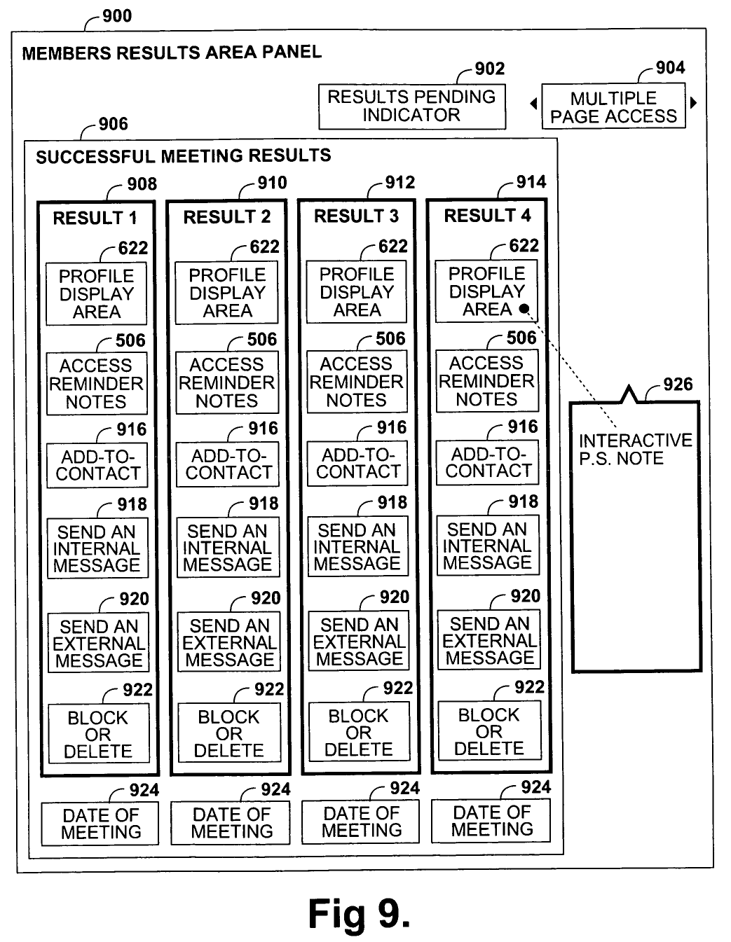

The system generates only two types of Results from matched Meeting Partners: Successful and Unsuccessful. It requires both Meeting Partners to submit a YES Vote in order for the Meeting 412 to be successful. If successful, they will find each other's details listed in their Members Results Area 430 as shown in FIG. 9.

Unsuccessful Meeting Partners are those between whom at least one Member has either voted NO, or where at least one Member has not completed a YES or NO Vote 416 to the other Member. The system may count incomplete votes as a NO vote. The system can choose not to provide further information or communication between system unsuccessful Meeting Partners and unsuccessful Meeting Partners may not be listed in the Members Results Area 430.

Secondly, the system encourages a friendly and responsible community where it is mandatory for each Member, during the Voting Interval 414, to rate the friendliness of every Meeting Partner by giving them a Friendly Feedback 418. To do this, Members are required to submit a rating that may be but is not limited to entering a value in a field, or using visual elements such as drop-down menus, steppers or sliders to select between a system minimum to maximum for ratings.

All Friendly Feedback 418 from Meeting Partners are then used to determine a Member's Friendly History 626. A Member's Friendly History 626 may be calculated as a computation on the average of all their Friendly Feedback 418 ratings to date. Every Member has a Friendly History 626 and this gets displayed in their visible profile while Meeting. A Member may also view their own Friendly History 626 in their Members Area 108. An algorithm that may be used to determine Friendly History 626 is:

1.

/* First Peer Rating */
i =1; where i represents the
Friendly History = Rating of ith Peer

2.

/* Nth Peer Rating */
N = i +1;
Friendly History = (Rating of Nth Peer + Rating of ith Peer) % N

Note that other computation methods may be implemented that may also incorporate normalization of the averages.

Thirdly, a Member can choose to use the time remaining till the next session to Create Reminder Notes 420 about the Meeting Partner. If the Meeting 412 result is successful, the Reminder Notes can be accessed along with other details of the successful Member in the Members Results Area 430.

Once a Member has submitted their Voting Interval 414 response, they will be prompted to wait for the next consecutive Meeting Session 312. If a Member did not finish submitting their response in time before the next Meeting 412 starts, they will still get a chance to complete any incomplete votes during the Review and Confirm Process 428.

If there was an Unsuccessful Match 310, as illustrated in FIG. 4 as Meeting Session 406, while a Member is waiting for the next session, the system may provide Interactive Activities 422 such as: Helpful information and relevant service statistics and updates; Options for Members to quickly promote the system to friends electronically; and Electronic gaming.

The technology used may allow Members to abort a Meeting 412 in progress and create a Disconnection 424. If a Member chooses to abort a Meeting 412 the system may communicate this as a ‘Connection Failure’, thereby making an actual Disconnection 424 due to a technical error indistinguishable from one that was invoked by an aborted Meeting 412. The advantage of this is that no Member will experience an obvious negative rejection. The reconnection procedure facilitates this further; to Reconnect 426 a Meeting Session 312 it requires both participating Members to commit to Reconnect 426 the Meeting. If one or both of the Members chooses not to Reconnect 426, they will not be Reconnected 426 and they will either be requested to wait for the next Meeting or, if it was a Members last Meeting Session 312, they will proceed to the Review and Confirm Process 428.

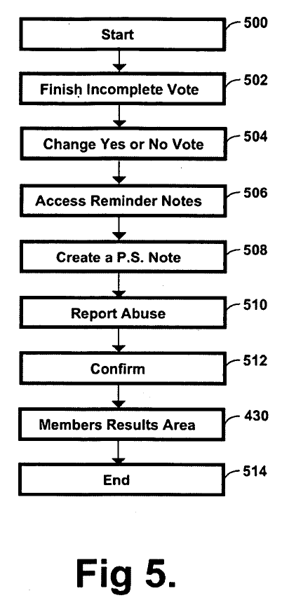

Once all Meeting Sessions 312 are finished, a Member is Checked-Out 314, making them no longer available to be matched for Meeting, and the Review and Confirm Process 428, shown in FIG. 5, commences. Once the Review and Confirm Process 428 is complete the Member can choose to Continue with Meetings, and activate the Check-in Process 300 again, or End 434 the current Meeting Process 110 and proceed to review their Results in the Members Results Area 430.

Now referring to FIG. 5, once all of a Member's Number of Meeting Sessions 210 are finished, the Member is presented the history of their Meeting Sessions 312 in order to complete the Review and Confirm Process 428.

In the Review and Confirm Process 428, to Start 500, Members have the option to Finish Incomplete Votes 502. This is in case a Member ran out of time during the Voting Interval 414 submitting votes.

Members may also have the option to Change YES or NO Votes 504 in case a Member changes their mind to Change a YES to a NO Vote and vice versa.

Members may also have the option to Access Reminder Notes 506 where they can review and add to their notes about a Meeting Partner.

A unique element of the invention that the Review and Confirm Process 428 introduces is the option for Members to Create P.S. Notes 508 for any Meeting Partners they have submitted a ‘YES’ Vote for.

A P.S. Note 508 is a fun feature that aims to ignite communication only between system successful Meeting Partners. If a Member sends a P.S. Note 508 to a Meeting Partner they have submitted a “YES” vote for, and if the Meeting is successful, their Meeting Partner will be able to glide over some element of the sending Member's visible profile in their Members Results Area 430 to view the P.S. Note 508. A P.S. Note 508 may be in the form of text, audio or a video message.

Members may also have the option to Report Abuse 510 if they felt any of their Meeting Partners had acted inappropriately during the Meeting. Any Report Abuse 510 submitted may activate a Report Abuse System that is carefully designed to encourage responsible behavior while Meeting.

Once a Member has finished reviewing, they are required to Confirm 512 their votes. This Ends 514 the Review and Confirm Process 428. A Member's Results are then available in the Members Area Results 430 after a short period of time.

The system may also have a predetermined duration, where after if a Member is yet to Confirm 512 their votes, all votes previously submitted during the Voting Interval 414 will be treated as final. If they have not previously submitted a YES or NO Vote 416 for a Meeting during the Voting Interval 414, this may be treated as a NO vote.

Now referring to FIG. 6, illustrated is an example of the Meeting Console 600 design that may be utilized by the invention to present to a member while a Meeting 412 is in progress. This example is displaying the status of 4 Meeting Sessions 312 as shown with the Audio Video Window 612. The Meeting Console 600 is effectively an interactive control panel while Meeting 412. It is uniquely designed for ease of use to ensure a controlled Meeting experience where participating Members are prompted and guided at every stage of the Meeting Process 110.

While Meeting, the uniquely designed Meeting Console 600 displays the following: A Members Nickname Display 602, A Dynamic Console Heading 604, The Countdown Clock Display 102, Current Meeting Partner's Visible Profile 606, Audio Video Window 612, and A Dynamic Meeting Progress Panel 610.

All Members are required to submit a unique Nickname during registration to the system that becomes a Members Nickname Display 602 that is used by the system as a unique identifier for each Member.

A Dynamic Console Heading 604 is used to prompt the Member and also inform of their progress at each stage throughout the Meeting Process 11O. In this example it may show the Member they are in Meeting 3 of 4.

The Countdown Clock Display 102 counts down the time remaining for the Meeting 412 in progress.

The Current Meeting Partner's Visible Profile 606 is displayed. An example visible profile may display elements such as a Photo, Gender, Age, Location and a personalized debut message.

Also shown are the ID Validation Seal 608, Friendly History 626 and Compatibility Indicator 628 for the Current Meeting Partner.

The ID Validation Seal 608 is displayed if the Member has validated their identity to the system. A Member may utilize a recognized method to verify their true identity to the system in order to establish a level of integrity with their Meeting Partners. A submitted ID Validation Seal 608 indicates to a Meeting Partner or a potential candidate match that certain information a Member has posted in their Visible Profile 606 has been verified to be true in real life and this signals, to some extent, identity validity and integrity of the Member's Profile 606 details.

Friendly History 626 may be a computation on the average of all the Friendly Feedback 418 ratings for the Current Meeting Partner leading up to the current Meeting.

Compatibility Indicator 628 may be displayed as a visual indicator in any shape or form with the intention of communicating to Members a measure of how closely the Current Meeting Partner's desirables, attributes and Matching Preferences 208 match the Member's own.

Members can edit some elements of their visible profile, where as other elements such as Friendly History 626 and Compatibility Indicator 628 may be determined by the system.

The Audio Video Window 612 works synchronized with the Meeting Console 600. During a Meeting 412, the Audio Video Window 612 enables Meeting Partners to converse one on one using audio video interaction. At the end of a Meeting 412, the Audio Video Window 612 may cease to display any Audio Video interaction between system matched Meeting Partners.

The entire Audio Video Window 612 may be used to display a matched Meeting Partner real-time. Another method is to use a Picture-in-Picture (PIP) where a Member sees a small window within the Audio Video Window 612 that shows them their own live video as it is being streamed to their Meeting Partner. The rest of the Audio Video Window 612 is used to display the live video of their matched Meeting Partner.

The Dynamic Meeting Progress Panel 610 may be a scrollable panel that may display the progress of the Member's Meeting activity and can be used as a general reminder as the Member progresses through their chosen Number of Meeting Sessions 210.

A Member can Scroll 624 through the Dynamic Meeting Progress Panel 610 to view Meeting Sessions 312 so far. All previous Meeting Sessions 312 may show the YES or NO Vote 416 submitted, any incomplete votes, any Meetings that the system did not complete due to an Unsuccessful Match 310, Friendly Feedback 418 and the relevant Meeting Partner's Profile Display Area 622.

Any upcoming Meeting Sessions 312 may be left blank to ensure Members cannot see a future Meeting Partner's profiles before the Meetings occur. The benefits of withholding matched information before a Meeting 412 are: it keeps a surprise element of being matched real-time; it enables the system to match two Members at the very last moment before the next Meeting Session 312 starts; and it ensures Members do not abort an upcoming Meeting prematurely due to any prejudice against the upcoming matched partner's details displayed.

The Meeting Console 600 may use color to visually identify elements and status of the Meeting Session 312.

An example may be that during a Meeting Session 312, a male Meeting Partner's Profile Display Area 622 may be displayed with a different color than a female Meeting Partner. Another example may be that any previous Meetings voted YES, any previous Meetings voted NO, any previous Meetings that the system did not complete or a current Meeting 412 in progress may be highlighted using color differentiation.

For illustrative purposes, FIG. 6 shows an example of the Dynamic Meeting Progress Panel 610 showing: Previous Meeting One 614 has a YES vote submitted, Friendly Feedback 418 and the Meetings partner's Profile Display Area 622; Previous Meeting Two 616 has a NO vote submitted, Friendly Feedback 418 and the Meeting Partner's Profile Display Area 622; Current Meeting Three in Progress 618 and the current Meeting Partner's Profile Display Area 622 is shown and upcoming Meeting Four 620 is left blank.

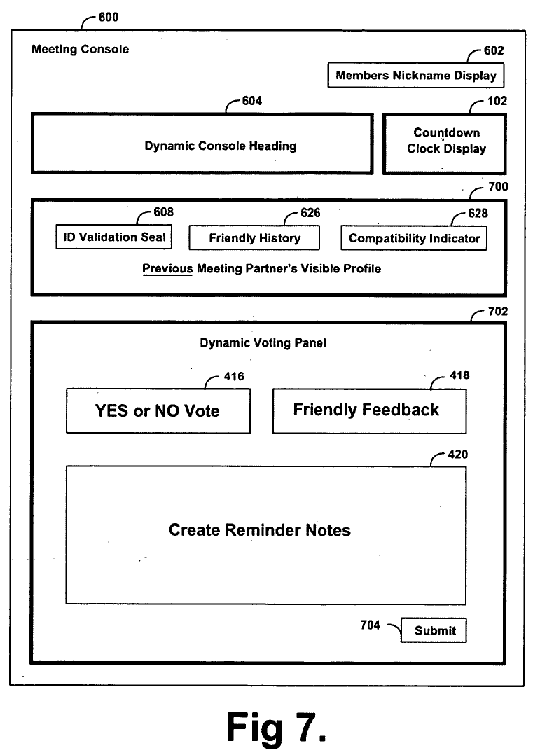

Now referring to FIG. 7, illustrated is an example of the Meeting Console 600 design that may be utilized by the invention to present to the member while the Voting Interval 414 is in progress. During a Voting Interval 414, the uniquely designed Meeting Console 600 displays the following: A Members Nickname Display 602; A Dynamic Console Heading 604 that is used to prompt the Member during the Voting Interval 414. In this example it may show the Member has one minute to rate a Meeting. The Countdown Clock Display 102 counts down the time remaining for the Voting Interval 414 in progress. The Previous Meeting Partner's Visible Profile 700, ID Validation Seal 608, Friendly History 626 and Compatibility Indicator 628 is displayed.

The Dynamic Voting Panel 702 has elements that allow Members to: Select a YES or NO Vote 416, provide a Friendly Feedback 418, Create Reminder Notes 420 about their Meeting in a textual field, and Submit 704 their voting information. If a Member runs out of time to Submit 704 their voting information before the next Meeting Session 312 starts, they can finish voting during the Review and Confirm Process 428.

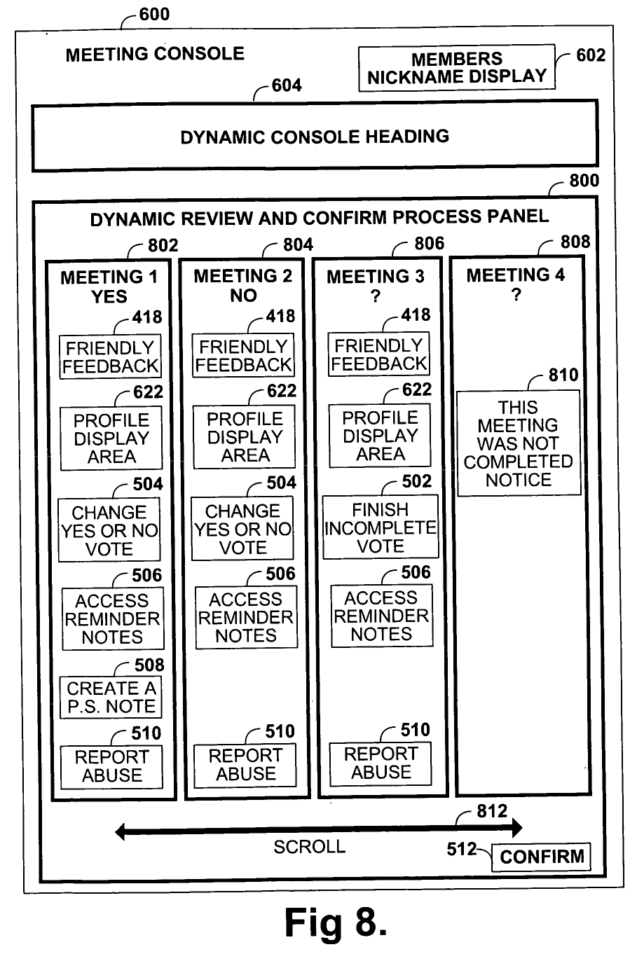

FIG. 8 is an example of the Meeting Console 600 design that may be utilized by the invention to present to the Member while the Review and Confirm Process 428 is in progress.

During a Review and Confirm Process 428, the uniquely designed Meeting Console 600 displays the following: A Members Nickname Display 602; A Dynamic Console Heading 604 is used to prompt the Member during Review and Confirm Process 428. In this example it may simply inform the Member that they are required to Review and Confirm their votes. Note that the system may choose not to display the Countdown Clock Display 102 in this console. This allows Members to take their time to finish the requirements of this process.

The Dynamic Review and Confirm Process Panel 800 displays a Member's previously completed Meeting activity. A Member may Scroll 812 through the panel to view their Meeting history.

The Friendly Feedback 418 the Member submitted for their Meeting Partner is displayed. Once submitted during the Voting Interval 414, Members may not be allowed to change this rating.

The Profile Display Area 622 may display selective information of matched partners. For Meetings that the system has not completed caused by Unsuccessful Matches 310, the Profile Display Area 622 may display a generic “This Meeting was not Completed Notice” 810.

A Member may have the option to Change a YES or NO Vote 504.

A Member may have the option to Finish an Incomplete Vote 502 where they may have either not voted or ran out of time during the Voting Interval 414, or there was a Disconnection 424 during a Meeting.

A Member may have the option to Access Reminder Notes 506 where they can review any previously submitted notes and add to them or if a Member did not submit any notes during the Voting Interval 414 they can start creating notes.

A Member may have the option to Create a P.S Note 508 only for those Meeting Partners they have voted YES to.

The Member may have the option to Report Abuse 510 against a Meeting Partner for any behavior that they feel may be considered inappropriate. Next, a Member can choose to Confirm 512 their voting.

For illustrative purposes, FIG. 8 shows an example of the Dynamic Review and Confirm Process Panel 800 displaying four Meeting Sessions 312.

Meeting One 802 has a YES vote submitted, Friendly Feedback 418, the Meeting Partner's Profile Display Area 622 that helps remind the Member of their Meetings partners, an option to Change a YES or NO Vote 504, Access Reminder Notes 506, an option to Create a P.S. Note 508 and an option to Report Abuse 510.

Meeting Two 804 has a NO vote submitted, Friendly Feedback 418, the Meetings partner's Profile Display Area 622, an option to Change a YES or NO Vote 504, Access Reminder Notes 506 and an option to Report Abuse 510.

Meeting Three 806 has a “?”, which means a YES or NO Vote 416 or Friendly Feedback 418 was not submitted. Meeting Three 806 displays the Meetings partner's Profile Display Area 622, an option to Finish an Incomplete Vote 502, Access Reminder Notes 506 and an option to Report Abuse 510.

Meeting Four 808 has a “?” which means a YES or NO Vote 416 or Friendly Feedback 418 was not submitted. Meeting Four 808 displays a “This Meeting was not Completed Notice” 810 which means Meeting Four 808 was not completed due to an Unsuccessful Match 310.

FIG. 9 is an example of the Members Results Area Panel 900design that may be utilized by the invention for Members to view their Successful Meeting Results 906.

The Members Results Area Panel 900may display, at any given time, a set number of successful Meeting Partners visually in the panel. For illustrative purposes, FIG. 9 shows an example of four Successful Meeting Results 906 that are displayed as Result One 908, Result Two 910, Result Three 912 and Result Four 914. If a Member has more successful partners than what can be shown visually in the panel at one time, the Member may have the option to use the Multiple Page Access 904 to see partners he or she currently cannot see on the screen.

The most recent Successful Meeting Results 906 display first. Any new Successful Meeting Results 906, seen for the first time, may be highlighted using color differentiation. The Members Results Area Panel 900 may also display a Results Pending Indicator 902 communicating to the Member if any results from previous Meeting Sessions 312 are still awaiting confirmation.

Each successful Meeting may be displayed as the following example, as shown on FIG. 9: The Profile Display Area 622 may display selective information on the successful Meeting Partner. A Member has the option to Access Reminder Notes 506 where they can review any previously submitted Reminder Notes 506 and add to them. If a Member did not submit any notes during the Voting Interval 414, they can start creating notes.

A Member may have the Option to Add-to-Contact 916 for popular one or many IM applications and address books, VOIP or other audio video interaction platforms and applications and electronic social networks to communicate with successful Meeting Partners on a preferred and personal level outside the system.

A Member may have the Option to Send an Internal Message 918. The methods incorporate a unique internal message service only for successful Meeting partners to communicate within the system in a fast, effective way as an alternative to other choices for further communication.

A Member may have the Option to Send an External Message 920. The methods incorporate an External message service only for successful Meeting partners to communicate in a fast, effective way as an alternative to other choices for further communication. Also External messages may carry the system name as the sender. This allows Members to remain anonymous by keeping their electronic device details private. External Messaging may be a free or a paid service.

A Member may have the Option to Block or Delete 922 a successful Meeting Partner. If the Member Blocks a successful Meeting Partner, the system respects that this decision may be temporary and that the Member may choose to Unblock the partner after sometime. Therefore, the system may not delete the partners profile from their Members Results Area Panel 900, but visually flag that the Member has been blocked. The system may present the option to Unblock the Meeting Partner. If a blocked successful Meeting Partner attempts to communicate to the Member via the system, they may be informed that the Member may not be available for communication.

If the Member Deletes a successful Meeting Partner, the system respects this and may delete the partners profile from their Members Results Area Panel 900. If the deleted successful partner attempts to communicate to the Member via the system, they may be informed that the Member is no longer available for communication Successful Meeting Results 906 may display the Date of the Meeting 924 showing the day, month and year each Meeting Session 312 occurred.

The Interactive P.S. Note 926 may be displayed when the successful Meeting recipient glides over some element of the sending successful Meeting Partner's Profile Display Area 622. The Interactive P.S. Note 926 may be text, audio or a video message.

Now referring to FIG. 10, the present invention introduces Interactive Statistic Displays 104, using an example of an Interactive Map. Interactive Statistic Displays 104 will synchronize to the Timer Device 100 and any major processes of the system necessary in order to capture, compute and present key usage information to Members.

This information may help influence a Member's Meeting Session 312 choices, such as there preferred times of use and target locations to seek Meeting partners and it may also promote purchasing. The system may also allow Members to add and plot engaging information to Interactive Statistic Displays 104 on shared and private statistics areas of the system.

FIG. 10 is an example of an Interactive Statistic Display 104 that may be displayed in the Members Area 108. An immediate benefit of this display is that as soon as a Member accesses their Members Area 108, they can utilize the Interactive Map 1006 to visually check the number of Members currently logged in to their target locations. This may influence them to check-in and select a target location where they know a significant number of Members are currently available for Meeting.

In this example, the Interactive Statistics Processor 1000 utilizes the Timer Device 100 and the Service Database 1002 for Processing of Usage Information 1004 to generate information that is used to populate the Interactive Statistics Display 104.

This Interactive Statistics Display 104 example displays three areas: an Interactive Map 1006 where Members can interact with Locations on the map; an Interactive Map Statistics Display Area 1008 that presents statistics on the Location being interacted with; and a Feeds 1010 area that presents additional live information and statistics, and other syndicated and aggregated content and advertisements.

An Interactive Map 1006 could use a variety of map overlay methods to present location-based information directly on the Interactive Map 1006. The system may also use colors or visual indicators in any shape or form with the intention of distinguishing points, lines, locations or other elements on the map. For this example in FIG. 10, when a Member interacts with a target Location on the map, location-specific statistics are presented in the Interactive Map Statistics Display Area 1008. Types of statistics displayed may be but are not limited to live statistics and trend estimation statistics.

An example of a live statistic presented in the Interactive Map Statistics Display Area 1008 may be that the system utilizes the Timer Device 100 and Check-in Process 300 to determine the total Number of Members Live who are currently checked-in for Meetings in a target location.

An example of a trend estimation statistic presented may be that the system utilizes the Timer Device 100 and Meeting Process 110 to enable Processing of Usage Information 1004 that can be compared to the Service Database 1002, that holds Member information, to estimate dynamic usage trends such as a target location's Most Popular Time of Usage, that gets displayed The system may further utilize the Timer Device 100 to determine the current local time for the Member who is interacting with the map and converts the most Popular Time of Usage for a target location to the Member's equivalent local time. This gets displayed in the Interactive Map Statistics Display Area 1008 along with the name of the target Location.

The Feeds 1010 Area in this example has the areas: Live Statistics 1012, Service Statistics 1014, Service Updates 1016 and the Advertising System 1018.

An example of a Live Statistics 1012 in the Feeds 1010 area may be the display of the total number of Members live at popular locations for the system around the world. An example of a Service Statistics 1014 in the Feeds 1010 area may be the display of the recent popular times of use of the system globally, which may further be converted to their local time. Another example of a Service Statistics 1014 may be the display of the most popular time of use of a Members several preferred target locations converted to their local time.

An example of Service Updates 1016 may be to display a snippet of information about a new feature of the system. An example of content the Advertising System 1018 area may display is Contextual Advertisements based on a Member's current location or on target locations that the Member frequently selects to seek Meeting Partners. Another example of content fed by the Advertising System 1018 may be the display of trend statistics such as the most popular items purchased by Members in a location or on the entire system. Selecting this Advertising System 1018 area may link Members to sections of the system that allows Members to purchase products and services.

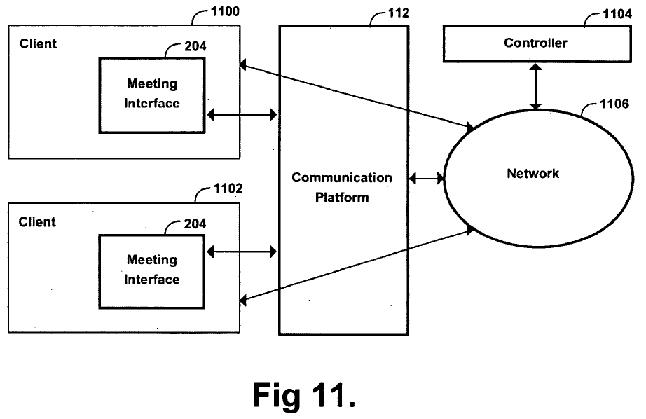

Now referring to FIG. 11, the IT Environment of the present invention is illustrated. The system illustrated in FIG. 11 includes a Network 1106 that enables a Controller 1104 to communicate with one or more Clients 1100 and 1102 via a Communication Platform 112. The Controller 1104 houses systems for the major processes including the Matching Process 402, Timer Device 100 and statistics Feeds 1010. A suitable Controller 1104 might be but is not limited to a computer software application which is deployed on a the system server or an application server, a software program which is running on a softswitch, a voice server or a telephony server. The Controller 1104 could also be a combination of such devices.

The Meeting Interface 204, Countdown Clock Display 102, Meeting Console 600, Public Area 106, Members Area 108 and the Interactive Statistics Display 104 are integral parts of the client 1100 and 1102, which are governed by the Controller 1104. The Meeting Interface 204 interacts and communicates with a node in the Communication Platform 112, which acts as the medium for sending video and audio content to Meeting Members. Accessible by the client 1100 and 1102, a node in the Communication Platform 112 sends and receives video and audio content from another node in the Network 1106.

Suitable clients 1100 and 1102 include, but are not limited to the system browser, a client side application or a client application that is capable of interfacing with the communications Network 1106 and the Communication Platform 112. Suitable clients may run on a Member's system and audio video interaction-enabled equipment that may include but are not limited to a system-enabled computer or mobile device, a system-enabled TV device or a system-enabled gaming console. Suitable networks for communication between the system Controller 1104 and the Clients 1100 and 1102 include, but are not limited to, the Internet, an intranet, an extranet, a virtual private network (VPN) and non-TCP/IP based networks. The Communication Platform 112 might be but is not limited to popular IM applications, VOIP or other audio video interaction platforms and applications and electronic social networking platforms and applications.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. A method for a plurality of users to be simultaneously matched to interact one on one in a live controlled environment comprising the steps of:
providing a Public area and Members area;
providing a Matching Process to identify candidate matches for Members based on their Matching Details;
providing a Meeting Interface that works with the Communication Platform to allow Audio Video interaction between Members;
said Meeting Interface consists of hardware and software working together to allow electronic Meeting capability on a system-enabled electronic device using a variety of methods.
presenting to Members a Meeting Console providing an interactive control panel for Meeting via the Meeting Interface;
conducting a Meeting Session on a communication platform that provides means for audio video interaction capabilities;
managing and ensuring a continuous succession of Meeting Sessions synchronized via a Timer Device;
providing a Countdown Clock Display, governed by said timer device, in both the public and member areas communicating the continuous succession of Meeting Sessions and time duration within Meeting Sessions;
conducting each Meeting Session on a communication platform that provides means for audio video interaction capabilities; and
executing the live controlled environment as an electronic environment on a plurality of system-enabled electronic devices.

2. The method of claim 1 wherein, when using the Countdown Clock Display, Members can initiate a Check-in Process to make themselves available for Meeting further comprising the steps of:
accessing the Members Area to initiate the Check-in Process;
displaying a series of timed activation alerts that are synchronized to the Countdown Clock Display;
visually transitioning alerts from one to another at specific times to indicate the urgency of limited Check-in time remaining to join a next Meeting Session; and
communicating the continuous succession of Meeting Sessions.

3. The method of claim 2 wherein,
communicating to visitors and Members, via the Countdown Clock Display, a continuous count down cycle that runs real-time every few minutes to indicate exactly when a Meeting Session will start and end, unifying Meeting Session times across multiple time zones; and
repeating the cycle when the Countdown Clock Display has finished counting down the time remaining, the Check-in is closed for the upcoming Meeting Session and the Check-in Activation Alerts cycle starts all over again for the next Meeting Session.

4. The method of claim 1 wherein, the Timer Device allows the Countdown Clock Display, to count down each stage of the Meeting Session.

5. The method of claim 1 wherein, the Timer Device is also used to calculate various statistics that can be displayed using Interactive Statistics Displays, which appear in the Public Area, and Members Area.

6. The method of claim 2 wherein, the transitions between these visual alerts are indicated by change of color, form, or animation to indicate the urgency of limited time remaining to join the next Meeting Session.

7. The method of claim 2 further comprising the additional step of:
specifying Matching Details by submitting Matching Preferences,
selecting the Number of Meeting Sessions; and
viewing Matching Strength Meters.

8. The method of claim 7 wherein, matching is performed by:
using a very small number of specifics in order to achieve a greater aggregate of candidate matches;
specifying attributes and desirables sought in candidate matches and presenting character analysis methods and business intelligence in order to achieve closer matches;
specifying specific themed interests rather than only specific attributes and desirables in order to achieve closer matches; or
Dynamic Hotlist Matching wherein Members publish their planned Meeting information in advance to attract attention from prospective candidate matches.

9. The method of claim 8 wherein, the Dynamic Hotlist Matching further comprises:
a personal electronic calendar implementation allows publishing Members to select imminent calendar dates from a system personal electronic day/week/year calendar;
selecting particular calendar dates to specify any times for that day or night to indicate when a member is available for Meeting;
providing information about the member's location;
defining which type of Members they would like to share their times with;
showing information to prospective compatible Members when they are looking up imminent calendar dates from a personal electronic day/week/year calendar;
presenting a list showing compatible publishing Members available for Meeting at desired times;
creating lists showing publishing Members corresponding to these times;
communicating an interest for Meeting to publishing Members;
presenting publishing Members with an increasing list of prospective compatible Members who may be available and who have expressed interest in Meeting with them at their available times; and
filtering Members lists to create a list of the Members they may be interested in Meeting.

10. The method of claim 7 wherein, the Check-in Process requires members to select the consecutive Number of Meeting Sessions they would like to participate in;
communicates to Members how long it would take to complete their chosen Number of Meeting Sessions; and
providing one or more Matching Strength Meters that update real-time as a visual indicator displayed in any shape or form with the intention of communicating how selections or changes made to a Members matching preferences affect their matching potential.

11. The method of claim 1 wherein, the matching process further comprising the additional steps of:
a Check-in Process,
a Ranking Process requiring that Members be ranked according to certain criteria to formulate a list of checked-in Members,
a Matching Preferences Check requiring that a Member at the top of the list is selected and is attempted to be matched to the next on the list,
a Matched Previously Check providing that two Members of a possible match are checked if they have been matched previously on a Meeting,
a Successful Match producing a Meeting Session for the two Members;
an Unsuccessful Match resulting in the Member having to Skip a Session and wait for the next session, conducting a Meeting Session, and
a Check-Out process whereby once a Meeting session is over, and if a Member has checked in for more sessions, the Matching Process for this Member is started again at the Ranking Process, or once all sessions that the Member has checked-in for is complete, the Member is checked out of the Matching Process.

12. A Meeting system recorded on computer-readable medium and capable of execution by a system enabled device comprising:
a Controller that may consist of a software application which is deployed on the system or application server;
a software application which is running on a softswitch, a voice server or a telephony server; or a combination of such devices;
a Network that enables a Controller to communicate with one or more Clients via a Communication Platform;
said client governed by the controller and further consisting of a Meeting Interface, a Countdown Clock Display, a Meeting Console, a Public Area, a Members Area and an Interactive Statistics Display;
said Controller houses systems for the major processes including the Matching Process, Timer Device, and statistics Feeds;
the Meeting Interface interacts and communicates with a node in the Communication Platform, which acts as the medium for sending video and audio content to Meeting Members;
the Communication Platform, accessible by the client, sends and receives video and audio content from another node in the Network;
a Check-in Process for establishing availability of a plurality of Members;
a Matching Process wherein Members are matched for Meeting Sessions;
a Meeting Console including an Audio Video Window enabling the Members to interact with each other and a Countdown Clock Display that counts down the time remaining for each Meeting Session to finish;
a Meeting in the form of a one on one Audio Video connection between the system and two Members found to be compatible by the Matching Process;
a Check-Out Process;
a Review and Confirm Process, and
a Members Results Area.

13. The Meeting system of claim 12 where, the Meeting Console is further comprised of a Dynamic Console Heading providing the additional steps of:
prompting a Member of their progress at each stage of the Meeting Sessions;
prompting a Member to get ready and indicate the urgency of limited time remaining for a Meeting Session to commence or conclude; and
prompting a Member to get ready and indicate the urgency of limited time remaining for certain stages within the Meeting Sessions to commence or conclude; and
the Meeting Console displays the following in a Meeting, Voting Interval, and Review and Confirm Process:
a Members Nickname Display, a Dynamic Console Heading, a Countdown Clock Display, an Audio Video Window, a Dynamic Meeting Progress Panel and a Current Meeting Partner's Visible Profile, ID Validation Seal, Friendly History, and Compatibility Indicator in a Meeting;
a Members Nickname Display, a Dynamic Console Heading, a Countdown Clock Display, a Dynamic Voting Panel and a Previous Meeting Partner's Visible Profile, ID Validation Seal, Friendly History, and Compatibility Indicator in a Voting Interval; and
a Members Nickname Display, a Dynamic Console Heading and a Dynamic Review and Confirm Process Panel in a Review and Confirm Process.

14. The Meeting system of claim 12 wherein,
if a Successful Match is found, a Meeting Session is divided into two parts, a Meeting followed by a Voting Interval, both occurring for a controlled period of time;
the Meeting starts, a Countdown Clock Display counts down the time remaining for the Meeting to finish;
after a Meeting is complete, there is a Voting Interval for Members to submit a response about the most recently completed Meeting;
the Voting Interval starts, a Countdown Clock Display counts down the time remaining for the Voting interval to finish and the next Meeting Session to start;
during the Voting Interval, a Member is required to choose between a YES or NO Vote;
the system generates only two types of Results from matched Meeting Partners: Successful and Unsuccessful, requiring both Meeting Partners to submit a YES Vote in order for the Meeting to be successful, and if successful, they will find each other's details listed in their Members Results Area;
Unsuccessful Meeting Partners are those between whom at least one Member has either voted NO, or where at least one Member has not completed a YES or NO Vote for the other Member;
during the Voting Interval, it is mandatory for each Member to rate the friendliness of every Meeting Partner by giving them Friendly Feedback,
all Friendly Feedback from Meeting Partners are then used to determine a Member's Friendly History;
a Member's Friendly History is calculated as a computation on the average of all their Friendly Feedback ratings to date;
during the Voting Interval, a Member can Create Reminder Notes about the Meeting Partner, and if the Meeting result is successful, the Reminder Notes can be accessed along with the successful Meeting Partner's details in the Members Results Area;
once a Member has submitted their Voting Interval response, they will be prompted to wait for the next consecutive Meeting Session; and
if a Member did not finish submitting their response in time before the next Meeting starts, they will still get a chance to complete requirements of the Voting Interval during the Review and Confirm Process.

15. The Meeting system of claim 14 wherein,
once all Meeting Sessions are finished, a Member is Checked-Out, making them no longer available to be matched for Meetings, and the Review and Confirm Process commences;
once the Review and Confirm Process is complete the Member can choose to Continue participating in new Meeting Sessions, and activate the Check-in Process again, or End the current Meeting Process and proceed to review their Results in the member's area.

16. The method of claim 15 wherein, the Review and Confirm Process further comprising of the additional Steps of:
viewing the Friendly Feedback that Members submitted for their Meeting Partners;
presenting a Profile Display Area to show matched Meeting Partners for the completed Number of Meeting Sessions;
allowing Members to Change a YES or NO Vote;
accessing and adding to Reminder Notes; and
allowing members to report abuse.

17. The Meeting system of claim 16 wherein,
the Review and Confirm Process introduces the option for Members to Create P.S. Notes for any Meeting Partners they have submitted a ‘YES’ Vote for; and
a P.S. Note is in the form of text, audio, or a video message.

18. The Meeting system of claim 12, further comprising:
Interactive Statistics Displays synchronized to the Timer Device and any major processes of the system necessary in order to capture, calculate, and present statistics to Members;
Interactive Statistic Displays presented on shared and private statistics areas of the system that allow Members to add and plot engaging information to it;
said Timer Device determines the current local time for the Member who is interacting with the Interactive Statistics Displays and converts time-based statistics for target locations to the Member's equivalent local time;
the Interactive Statistics Display, presented in the Members Area as an Interactive Map allowing Members to visually check the number of Members currently logged in to a Member's target locations; and
said Interactive Statistics Display further comprised of:
an Interactive Map where Members can interact with Locations on a world map;
an Interactive Map Statistics Display Area that presents statistics on the location being interacted with; and
an Interactive Map Statistics Display Area that presents statistics on the Most Popular Times of Usage for a location being interacted with, converted to a Member's equivalent local time; and
an Interactive Map Statistics Display Area that presents statistics on the Most Popular Times of Usage of the system converted to Member's equivalent local time;
a Feeds area that presents additional live information and statistics, and other syndicated and aggregated content and advertisements; and
an Interactive Statistics Processor utilizing the Timer Device and a Service Database for Processing of Usage Information to generate information that is used to populate the Interactive Statistics Displays.

19. The Meeting system of claim 12 further comprising a Compatibility Indicator displayed as a visual indicator in any shape or form with the intention of communicating to Members a measure of how closely a Meeting Partner's desirables, attributes and Matching Preferences match the Member's own.

20. The Meeting system of claim 12, wherein the Members Results Area provides a Members Results Area Panel for Members to view and interact with their Successful Meeting Results, comprising the steps of:
presenting a Results Pending Indicator in order to visually communicate if some Results are still awaiting confirmation;
presenting a Profile Display Area showing selective information on successful Meeting Partners;
allowing Members to view any Interactive P.S Notes sent to them by a successful Meeting partner;
allowing Members to access and add to Reminder Notes;
allowing Members to add and invite successful Meeting Partners as a contact, allowing them to communicate outside the system;
allowing Members to send internal messages to successful Meeting Partners;
allowing Members to send external messages to successful Meeting Partners on electronic devices;
allowing Members to block and unblock successful Meeting partners; and
allowing Members to delete successful Meeting partners from the Members Results Area.
